(19) United States
(12) Patent Application Publication
(10) Pub. No.: US 2026/0154637 A1
(43) Pub. Date: Jun. 4, 2026

(54) DEMAND PREDICTION DEVICE, DEMAND PREDICTION SYSTEM, AND DEMAND PREDICTION METHOD

(71) Applicant: Mitsubishi Electric Corporation, Tokyo (JP)

(72) Inventor: Hiroyuki MORI, Tokyo (JP)

(73) Assignee: Mitsubishi Electric Corporation, Tokyo (JP)

(21) Appl. No.: 19/123,072

(22) PCT Filed: Dec. 7, 2022
(86) PCT No.: PCT/JP2022/045122

§ 371 Date: Apr. 22, 2025

(51) Int. Cl. G06N 20/00; G06Q 10/04; G06Q 10/087; G06Q 30/0202

(52) U.S. Cl. CPC G06Q 10/06315; G06Q 50/06

(57) ABSTRACT

A demand prediction device predicts an energy demand of a consumer at a prediction target date and time, and includes: an acquisition unit that acquires a past data set and a predicted value of a load item affecting the energy demand, the past data set including a past value of the load item and a past value of a demand item indicating the energy demand; a degree-of-similarity determination unit that determines a degree of similarity between the predicted value and past value of the load item, and extracts the past data set based on the degree of similarity; a regression formula deriving unit that derives a regression formula for predicting the energy demand based on the extracted past data set; and a predicted value calculation unit that calculates a predicted value of the demand item by applying the predicted value of the load item to the regression formula.

### TECHNICAL FIELD

The present disclosure relates to a demand prediction device configured to predict an energy demand by a consumer, a demand prediction system having the demand prediction device, and a demand prediction method.

### BACKGROUND ART

In the past, devices that predict electricity demand of a facility such as a factory to manage the energy consumption of the facility have been known (for example, Patent Literature 1). The device described in Patent Literature 1 performs demand prediction based on information on external or internal environments that affect the electricity demand. The external environment is, for example, temperature. Specifically, a correlation between the temperature and energy consumption is determined using data indicating past performance, and the energy consumption is predicted using the correlation (prediction formula) and a predicted temperature value for a prediction target day, which is a day for which energy demand is to be predicted. Additionally, the internal environment is, for example, the production plan of the factory. In this case as well, a correlation between the a contents of the factory and energy consumption is determined using data indicating past performance, and the energy consumption is predicted using this correlation and the information on a production plan for the prediction target day.

### CITATION LIST

### Patent Literature Patent Literature 1: International Publication No. 2017/051615

### SUMMARY OF INVENTION

### Technical Problem

A load of an internal environment of a consumer may have an unusual magnitude deviating from the past performance, for example, in the case where a prediction target day is a day just after a facility corresponding to the consumer reopens after a long holiday or an irregular event is held on the prediction target day, the internal environment can be considered to deviate from the past performance. Furthermore, a load of an external environment of the consumer, such as an outdoor temperature, may greatly vary depending on the time zone of the prediction target day. In such a case, the prediction accuracy of the device of Patent Literature 1 may be lowered.

The present disclosure is applied to solve the above problem, and relates to a demand prediction system, a demand prediction device, and a demand prediction method in which the accuracy of a demand prediction is improved.

### Solution to Problem

A demand prediction device according to an embodiment of the present disclosure predicts an energy demand of a consumer at a prediction target date and time, and includes: an acquisition unit configured to acquire a past data set and a predicted value of a load item that affects the energy demand, the past data set including a past value of the load item and a past value of a demand item indicating the energy demand; a degree-of-similarity determination unit configured to determine a degree of similarity between the predicted value of the load item and the past value of the load item, and extract the past data set based on the degree of similarity; a regression formula deriving unit configured to derive a regression formula for prediction of the energy demand that is made based on the extracted past data set; and a predicted value calculation unit configured to calculate a predicted value of the demand item by applying the predicted value of the load item to the regression formula.

A demand prediction system according to another embodiment of the present disclosure includes: the demand prediction device; a storage device configured to store the past data set and a predicted value of the load item; and a data acquisition device configured to acquire the past data set and the predicted value of the load item, and store the past data set and the predicted value of the load item in the storage device.

A demand prediction method according to still another embodiment of the present disclosure is a demand prediction method of predicting an energy demand of a consumer at a prediction target date and time, and includes: acquiring a past data set and a predicted value of a load item that affects the energy demand, the past data set including a past value of the load item and a past value of a demand item indicating the energy demand; determining a degree of similarity between the predicted value of the load item and the past value of the load item and extracting the past data set based on the degree of similarity; deriving a regression formula for prediction of the energy demand that is made based on the extracted past data set; and calculating a predicted value of the demand item by applying the predicted value of the load item to the regression formula.

### ADVANTAGEOUS EFFECTS OF INVENTION

In the demand prediction device, the demand prediction system, and the demand prediction method according to the embodiments of the present disclosure, the energy demand is predicted based on a data set that has a load item having a high degree of similarity to a prediction target date and time. Thus, the accuracy of the energy demand prediction is improved.

### BRIEF DESCRIPTION OF DRAWINGS

FIG. 1 is a schematic configuration diagram illustrating a demand prediction system according to Embodiment 1.

FIG. 2 is an explanatory view for an overall degree of similarity.

FIG. 3 is a hardware configuration diagram of a demand prediction device according to Embodiment 1.

FIG. 4 is a flowchart illustrating a demand prediction method according to Embodiment 1.

FIG. 5 is a flowchart illustrating a demand prediction method according to Embodiment 1.

FIG. 6 is a schematic configuration diagram illustrating a demand prediction system according to Embodiment 2.

FIG. 7 is a flowchart illustrating a demand prediction method according to Embodiment 2.

FIG. 8 is a flowchart illustrating the demand prediction method according to Embodiment 2.

FIG. 9 is another flowchart illustrating the demand prediction method according to Embodiment 2.

FIG. 10 is still another flowchart illustrating the demand prediction method according to Embodiment 2.

FIG. 11 is a flowchart illustrating a demand prediction method according to Modification 1 of Embodiment 2.

FIG. 12 is a flowchart illustrating steps of a demand prediction method according to Modification 2 of Embodiment 2.

FIG. 13 is a flowchart illustrating other steps of the demand prediction method according to Modification 2 of Embodiment 2.

FIG. 14 is a schematic configuration diagram illustrating a demand prediction system according to Embodiment 3.

FIG. 15 is a flowchart illustrating a demand prediction method according to Embodiment 3.

FIG. 16 is a flowchart illustrating the demand prediction method according to Embodiment 3.

FIG. 17 is a flowchart illustrating a demand prediction method according to Modification 1 of Embodiment 3.

FIG. 18 is a schematic configuration diagram illustrating a demand prediction system according to Embodiment 4.

FIG. 19 is a flowchart illustrating a demand prediction method according to Embodiment 4.

### DESCRIPTION OF EMBODIMENTS

### Embodiment 1

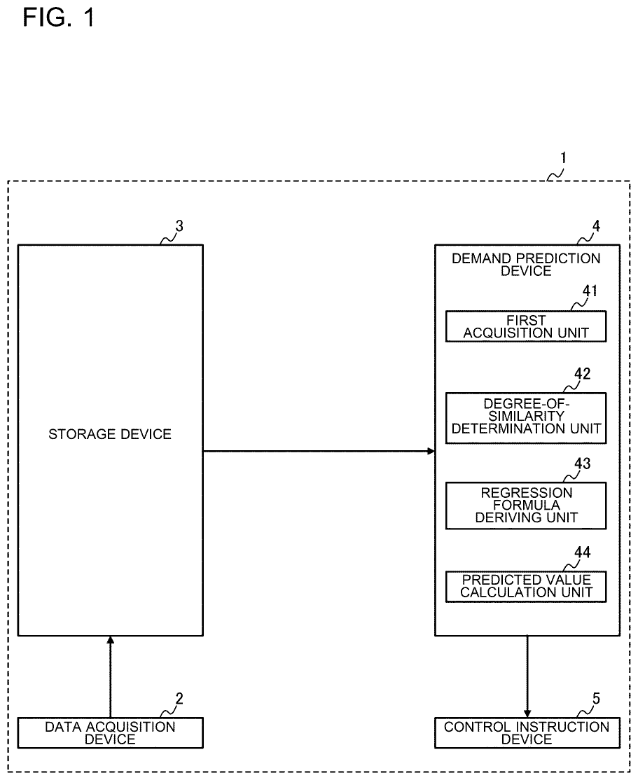

FIG. 1 is a schematic configuration diagram illustrating a demand prediction system 1 according to Embodiment 1. The demand prediction system 1 includes a data acquisition device 2, a storage device 3, a demand prediction device 4, and a control instruction device 5. The demand prediction system 1 predicts an energy demand of a consumer at a prediction target date and time.

The consumer refers to a facility, such as a factory, an office, a hotel, or a commercial building, a residential house or an apartment, or a group of these in a specific area. The prediction target date and time refers to the date and time for which the energy demand is to be predicted, such as the 24-hour period of the target day. It should be noted that the target date and time may be limited to a specific time within a day and the energy demand at the specific time may be predicted. Alternatively, the prediction target date and time may be set to a period of the target day that is longer than a day and the energy demand for the period may be predicted. It should be noted that the energy refers to electricity or heat that needs to be supplied to the consumer. In other words, the energy demand at the prediction target date and time is the amount of electricity or heat that needs to be supplied to the consumer per day.

The data acquisition device 2 is, for example, a computer and acquires data indicating energy demands measured in the past and past data regarding various factors affecting the energy demands. The data acquisition device 2 and the storage device 3 are connected to each other via a network, such as the Internet. The data acquisition device 2 classifies the acquired data into a plurality of data items, and then transmits data of the data items to the storage device 3 to store the data in the storage device 3. Among the data items, data items regarding energy demands will be referred to as demand items and data items regarding factors affecting the energy demands will be referred to as load items. As the data classified into the data items, for example, electricity demand data, heat-amount demand data, facility use data, equipment operation data, and weather data, which will be described later, are present. Among these data, the electricity demand data and the heat-amount demand data belong to the demand items, and the facility use data, the equipment operation data, and the weather data belong to load items. It should be noted that in the following description, a value indicated by data regarding a past event may be referred to as a past value regardless of how the data is acquired.

The data acquisition device 2 acquires data, using various methods each of which is applied based on the kind of data. Specifically, the data acquisition device 2 is connected to an energy management system that monitors and manages the supply of energy to the consumer. The data acquisition device 2 acquires past values of electricity demand data and heat-amount demand data from the energy management system. The electricity demand data indicates a date and time and an electricity that is to be supplied to the consumer at the date and time. The heat-amount demand data indicates a date and time and an amount of heat to be supplied to the consumer at the date and time.

The data acquisition device 2 acquires a past value of facility use data by accessing to, for example, a data server of the consumer via the Internet. The facility use data indicates a use schedule of the facility. The facility use data indicates, in the case where the facility is, for example, an office, a date and time and a usage state of a meeting room at the date and time. Similarly, in the case where the facility is a hotel, the facility use data includes a date and time and a usage state of a guest room at the date and time. It should be noted that the facility use data may be data obtained by integrating usage of a plurality of meeting rooms or guest rooms to indicate, for example, an operating status and an operating rate of the entire facility.

The data acquisition device 2 is connected to each of equipment that is associated with the consumer and acquires a past value of equipment operation data indicating an operation state of the equipment. It should be noted that the equipment is, for example, a household appliance provided in the consumer, such as an air-conditioning apparatus or a water heater, or a factory machine provided in the consumer. In the case where the equipment is, for example, an air-conditioning apparatus, the equipment operation data indicates a date and time, an on-or off-state and a set temperature at the date and time. Similarly, in the case where the equipment is a water heater, the equipment operation data indicates a date and time, and an on or off state and a hot water supply temperature at the date and time. The data acquisition device 2 may be connected to a sensor that measures physical quantities that vary in association with respective operations of equipment, and may be configured to acquire the physical quantity as equipment operation data. In this case, a sensor or a part of the data acquisition device 2 may be incorporated in each equipment.

The data acquisition device 2 acquires a past value of weather data via the Internet. The weather data includes a date and time, and also weather, outdoor temperature, humidity, an amount of solar radiation, and other data at the date and time in a region where the consumer is present.

Furthermore, the data acquisition device 2 acquires data of demand items, which can be used to predict a state at a prediction target date and time, and transmits the data to the storage device 3 to store the data in the storage device 3. For example, regarding the facility use data, in the case where the facility is an office, for example, it is possible to predict a state at a prediction target date and time by referring to the reservation status of the meeting rooms. Similarly, in the case where the facility is a hotel, for example, it is possible to predict a state at a prediction target date by referring to the reservation status of the guest rooms. Regarding the weather data, by referring to a weather forecast, it is possible to predict a state at a prediction target date and time. Furthermore, regarding the equipment operation data, in the case where an operation plan for each equipment is determined in advance, it is possible to predict a state at the prediction target date and time by referring to the operation plan. It should be noted that in the following description, a value indicated by data predicted for a future event may be referred to as a predicted value regardless of how the data is acquired.

The storage device 3 is, for example, a non-volatile semiconductor memory such as a read only memory (ROM), a flash memory, an erasable and programmable ROM (EPROM), or an electrically erasable and programmable ROM (EEPROM). The storage device 3 stores past values of the data transmitted from the data acquisition device 2 on a time-series basis based on the target time period to which the data of each data item is related. The past values of data of a plurality of data items that are stored on a time-series basis are divided for respective set time periods and the past values for each set time period are used as one past data set. The set time period for a past data set is, for example, 24 hours. A target date and time for data included in a past data set is referred to as an acquisition target date and time.

Furthermore, the storage device 3 stores predicted values of data of demand items that is transmitted from the data acquisition device 2, for respective data items and for respective target dates and times. Predicted values of data of a plurality of data items are divided and the predicted value of the data for each prediction target date and time is used as one prediction data set. It should be noted that in the following description, in the case where the past data set and the prediction data set are not distinguished from each other, these data sets are each simply referred to as a data set

In the storage device 3, the data set is classified into attributes. The attribute is used to classify the data set into categories of a summer period, an intermediate period, and a winter period by using the acquisition target dates and times of the past data set and the prediction target dates and times of the prediction data set. In addition, the data sets may be classified into categories of a weekday and a holiday.

The demand prediction device 4 is, for example, a computer, and predicts an energy demand of the consumer; that is, calculate a predicted value of data of a demand item. The calculated energy demand is transmitted to the control instruction device 5. The demand prediction device 4 includes a first acquisition unit 41, a degree-of-similarity determination unit 42, a regression formula deriving unit 43, and a predicted value calculation unit 44. The storage device 3 and the demand prediction device 4 are connected to each other via a network, such as the Internet. In addition, the demand prediction device 4 and the control instruction device 5 are connected to each other via a network, such as the Internet.

The first acquisition unit 41 acquires from the storage device 3, a predetermined amount of past data sets and a prediction data set of a prediction target date and time via the network. The predetermined amount is, for example, all the past data sets stored in the storage device 3.

The degree-of-similarity determination unit 42 determines the degree of similarity regarding the load item between the acquired past data sets and the acquired prediction data set, and extract, from among the acquired past data sets, a past data set having a high degree of similarity regarding the load item and the prediction target date and time. Specifically, the degree-of-similarity determination unit 42 determines a degree of similarity between a predicted value of a load item at the prediction target date and time and a past value of the load item for a past data set. The degree of similarity is calculated by, for example, calculating an error between the predicted value of the load item and the past value of the load item, and is determined such that the smaller the error, the higher the degree of similarity. It should be noted that the above error is, for example, a root mean squared error (RMSE). The degree-of-similarity determination unit 42 determines the degree of similarity regarding each of load items, and then, based on the degrees of similarity, determines the overall degree of similarity for the past data set. The degree-of-similarity determination unit 42 makes determination of the overall degree of similarity for all the acquired past data sets and compare these degrees of similarity. The degree-of-similarity determination unit 42 extracts a predetermined number of past data sets in descending order with respect to the overall degree of similarity. The predetermined number is an arbitrary number determined by a user in advance.

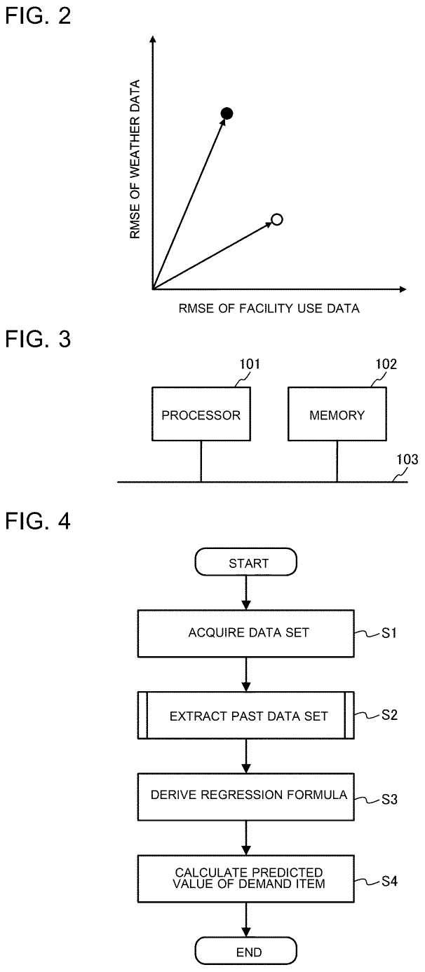

FIG. 2 is an explanatory view for the overall degree of similarity. In a method for calculating the overall degree of similarity, for example, degrees of similarity are plotted on a graph, as illustrated in FIG. 2, and distances from an original point are used. In an example of FIG. 2, an RMSE value of weather data and an RMSE value of facility use data are individually calculated and points corresponding to the RMSE values in two dimensions are plotted as overall RMSE values. In addition, overall RMSE values are plotted for multiple past data sets. Specifically, a black circle and a white circle indicate respective overall RMSE values of past data sets of different acquisition target dates and times. The plotted overall RMSE values are compared based on the distances from the original point and the determination is made such that the closer the overall RMSE value to the original point, the higher the overall degree of similarity of the overall RMSE value. In the example of FIG. 2, the past data set plotted as the white circle has a smaller overall error than the past data set plotted as the black circle, and is considered to have a higher overall degree of similarity.

The regression formula deriving unit 43 derives a regression formula for prediction of an energy demand that is made based on all the past data sets extracted by the degree-of-similarity determination unit 42. In this case, in all the extracted past data sets, a regression formula is derived using a value of data of each load item as an explanatory variable and a value of data of a demand item as an objective variable.

The predicted value calculation unit 44 calculates a predicted value of a demand item by applying a predicted value of data of a load item to the regression formula derived by the regression formula deriving unit 43, and transmits the calculated predicted value to the control instruction device 5 via the network.

The control instruction device 5 is, for example, a computer, and converts the calculated predicted value of the demand item into a control instruction for controlling each equipment of the consumer, and transmits the control instruction to a device that controls the equipment. The control instruction may include an operation plan of each equipment that is optimized by using the predicted value of data of the demand item. In addition, the control instruction may include a control numerical value to make an instruction for operating the equipment.

FIG. 3 is a hardware configuration diagram of the demand prediction device 4 according to Embodiment 1. As illustrated in FIG. 3, the demand prediction device 4 includes a processor 101, such as a central processing unit (CPU), and a memory 102. Each of functions of the demand prediction device 4 is fulfilled by the processor 101 and the memory 102. FIG. 3 shows that the processor 101 and the memory 102 are connected to each other via a bus 103 such that the processor 101 and the memory 102 can communicate with each other. It should be noted that in the case where the data acquisition device 2 and the control instruction device 5 are computers, the data acquisition device 2 and the control instruction device 5 have the same configuration as the demand prediction device 4.

Functions of the demand prediction device 4 are fulfilled by software, firmware, or a combination of software and firmware. The software or the firmware is written as a program and is stored in the memory 102. The processor 101 reads out and execute the program stored in the memory 102, to thereby fulfill each of the functions.

The memory 102 is a non-volatile semiconductor memory, such as a ROM, a flash memory, an EPROM, or an EEPROM. Furthermore, as the memory 102, a volatile semiconductor memory, such as a random access memory (RAM), may be used. In addition, as the memory 102, a removable storage medium, such as a magnetic disk, a flexible disk, an optical disk, a compact disc (CD), a mini disc (MD), or a digital versatile disc (DVD) may be used.

FIG. 4 is a flowchart illustrating a demand prediction method according to Embodiment 1. A schematic flow of processes that are executed until an energy demand is calculated will be described with reference to FIG. 4. First of all, the first acquisition unit 41 of the demand prediction device 4 acquires a predetermined amount of past data sets accumulated in the storage device 3 and a prediction data set of a prediction target date and time (step S1). Then, the degree-of-similarity determination unit 42 determines the overall degree of similarity of the past data sets, and extracts, based on these degrees of the similarities, a past data set having a high degree of similarity to the prediction data set of the prediction target date and time (step S2). Then, the regression formula deriving unit 43 derives a regression formula for calculating a predicted value of data of a demand item based on the extracted past data sets (step S3). Subsequently, the predicted value calculation unit 44 calculates the predicted value of the data of the demand item from a predicted value of data of a load item of the prediction target date and time, by using the regression formula derived by the regression formula deriving unit 43 (step S4).

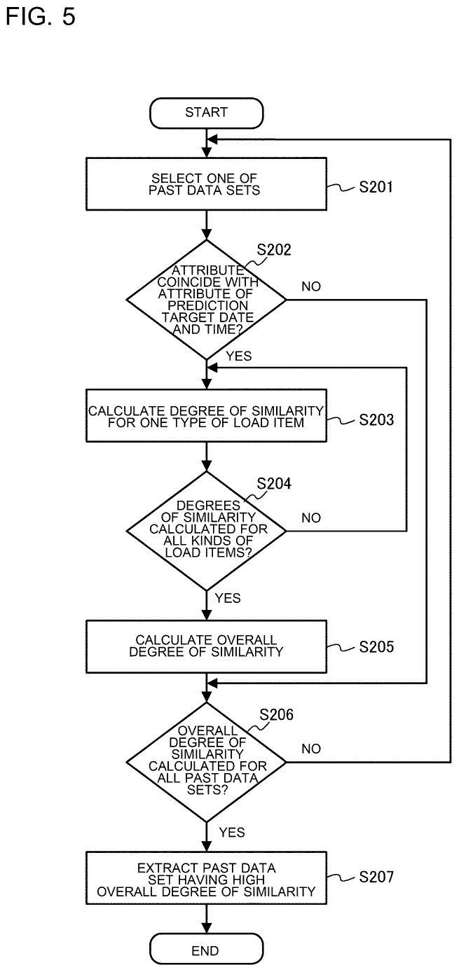

Furthermore, the determination of the degree of similarity and the extraction of a past data set will be described in detail. FIG. 5 is a flowchart illustrating the demand prediction method according to Embodiment 1. In FIG. 5, the process of step S2 in FIG. 4 is illustrated in detail. It should be noted that the following description is made by referring to by way of example the case where the set time period for past data set is 24 hours. First, the degree-of-similarity determination unit 42 selects a past data set of one day before the prediction target date and time (step S201). Next, the degree-of-similarity determination unit 42 determines whether or not the attribute of this past data set coincides with the attribute of the prediction data set. When these attributes do not coincide with each other (No in step S202), the degree-of-similarity determination unit 42 does not determine the degree of similarity of the past data set but performs process of step S206.

When the above attributes coincide with each other (Yes in step S202) with respect to one kind of load item included in the acquired past data set, the degree-of-similarity determination unit 42 determines the degree of similarity between a past value included in the past data set and the predicted value of the prediction target date and time (step S203). Then, the degree-of-similarity determination unit 42 determines whether or not the degree of similarity is determined for all kinds of the load items included in the acquired past data set (step S204). When the degree of similarity is not determined for all the kinds of the load items (No in step S204), the degree-of-similarity determination unit 42 repeats the process of step S203 for unselected load items until the degree of similarity is determined for all the kinds of the load items.

When the degree of similarity is determined for all the kinds of the load items (Yes in step S204), the degree-of-similarity determination unit 42 determines the overall degree of similarity (step S205). Then, the degree-of-similarity determination unit 42 determines whether or not the determination of the overall degree of similarity for each of all the acquired past data sets is completed (step S206). When the determination of the overall degree of similarity for each of all the acquired past data sets is not completed (No in step S206), the degree-of-similarity determination unit 42 repeats the processes of steps S201 to S205, while going back one day at a time from the acquired target date and time of the past data set until the determination of the overall degree of similarity for each of all the acquired past data sets is completed.

When the determination of the overall degree of similarity for each of all the acquired past data sets is completed (Yes in step S206), the degree-of-similarity determination unit 42 extracts past data sets of a predetermined number of days in descending order of the overall degree of similarity (step S207).

As described above, in the demand prediction device 4 and the demand prediction method of Embodiment 1, an energy demand is predicted based on a past data set having a high degree of similarity regarding the load item to the data set of the prediction target date and time. Thus, the accuracy of an energy demand prediction is improved. In particular, even in the case where a load fluctuation is unusual, an energy demand can be predicted based on this load.

Furthermore, the overall degree of similarity regarding the load item is determined in consideration of data associated with an external environment of the consumer, such as weather data and data associated with an internal environment of the consumer, such as facility use data or equipment operation data. Thus, the accuracy of the energy demand prediction can be improved even in a special case where the load fluctuation deviates from the past results, such as time immediately after a facility reopens from a long holiday, in the case where an irregular event is held, or in the case where an outdoor temperature changes suddenly.

### Embodiment 2

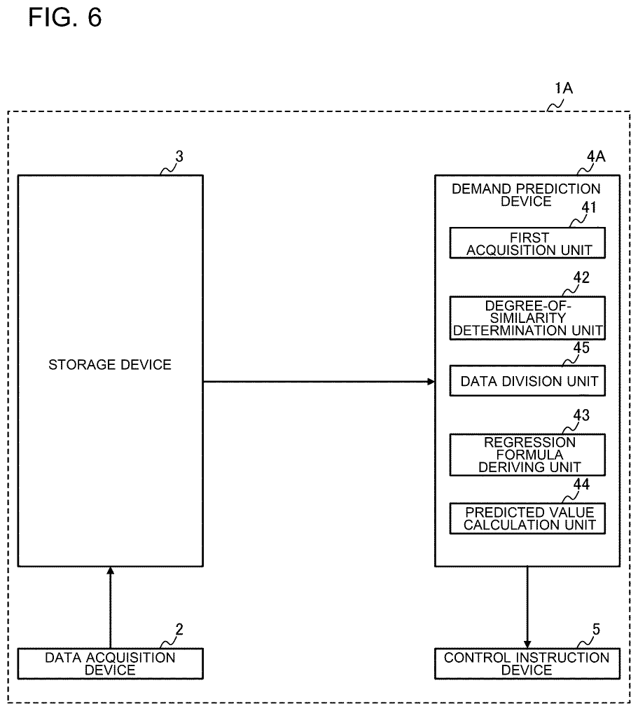

FIG. 6 is a schematic configuration diagram illustrating a demand prediction system 1A according to Embodiment 2. As illustrated in FIG. 6, a demand prediction device 4A according to Embodiment 2 includes a data division unit 45. In this regard, Embodiment 2 is different from that of Embodiment 1. Regarding Embodiment 2, components that are the same as those of Embodiment 1 will be denoted by the same reference signs and their descriptions will thus be omitted. The following description regarding Embodiment 2 is made by referring mainly to the differences between Embodiments 1 and 2.

The data division unit 45 divides a past data set extracted by the degree-of-similarity determination unit 42 into a plurality of sections with reference to time. Specifically, the data division unit 45 acquires based on the facility use data, an operation start time and an operation end time of a facility that is a consumer, for each of all the extracted past data sets. Then, all the extracted past data sets are divided into three time zones that are a time zone before the start of the operation of the facility, a time zone during the operation, and a time zone after the end of the operation, respectively. It should be noted that the data division unit 45 may divide the past data sets not based on the facility use data but based on an operation start time and an operation end time of the facility that are specified by the user. As described above, each of past data sets is divided for respective set time zones. For example, in the case where a day is divided in association with one past data set, the past data set is divided and classified into three time zones of the day.

The regression formula deriving unit 43 derives a regression formula for each of sections obtained by division by the data division unit 45. That is, the regression formula is derived on the basis of data of a section before starting the operation of the facility, in all the extracted past data sets. Similarly, a regression formula is derived on the basis of data of a section during the operation of the facility, in all the extracted past data sets. In addition, a regression formula is derived on the basis of data of a section after ending the operation of the facility, in all the extracted past data sets.

The predicted value calculation unit 44 calculates a predicted value of a demand item by applying a predicted value of a load item of a prediction target date and time to the regression formula of each section derived by the regression formula deriving unit 43.

The control instruction device 5 determines a regression formula associated with a section that coincides with a load state in the consumer during control, converts a predicted value calculated by this regression formula, and transmits a control instruction.

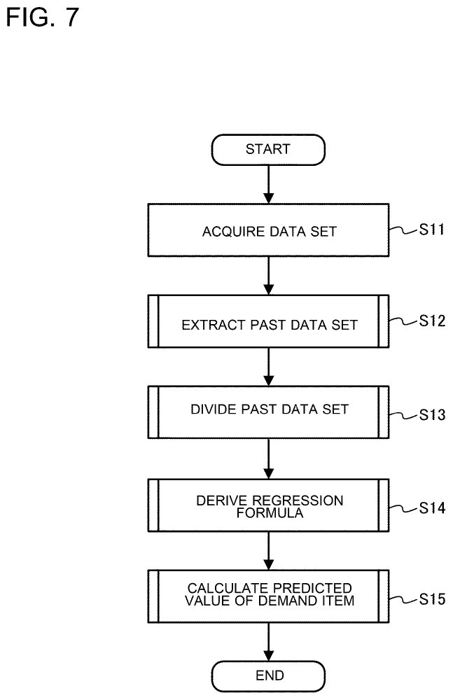

FIG. 7 is a flowchart illustrating a demand prediction method according to Embodiment 2. A schematic flow of processes that are executed until an energy demand is calculated will be described with reference to FIG. 7. First, the first acquisition unit 41 of the demand prediction device 4A acquires a predetermined amount of past data sets accumulated in the storage device 3 and a prediction data set of a prediction target date and time (step S11). Then, the degree-of-similarity determination unit 42 determines overall degrees of similarity of the past data sets, and extracts, based on these degrees of similarity, a past data set having a high degree of similarity to the data set of the prediction target date and time (step S12). Then, the data division unit 45 divides the extracted past data set into a plurality of sections (step S13). Next, the regression formula deriving unit 43 derives a regression formula for calculating a predicted value of a demand item for each section of the extracted past data set (step S14). Then, the predicted value calculation unit 44 calculates a predicted value of the demand item from a predicted value of a load item of the prediction target date and time based on the regression formula derived by the regression formula deriving unit 43 (step S15).

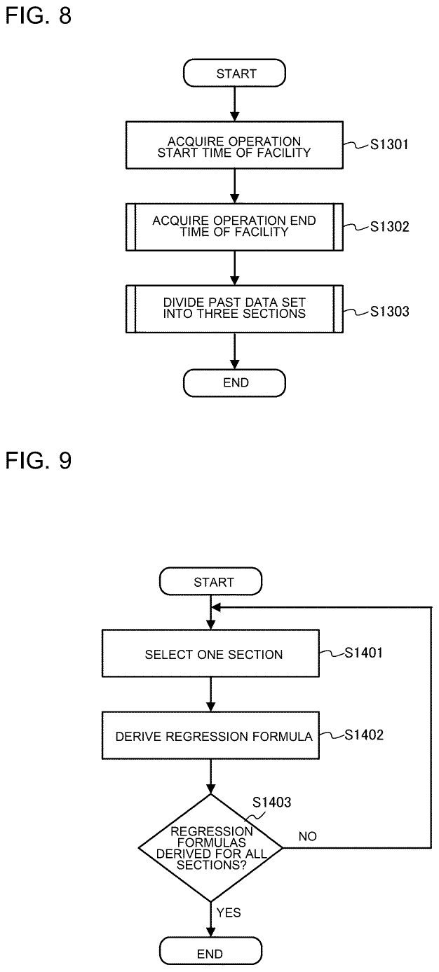

Furthermore, the division of the past data set will be described in detail. FIG. 8 is a flowchart illustrating the demand prediction method according to Embodiment 2. In FIG. 8, the process of step S13 in FIG. 7 is illustrated in detail. First, the data division unit 45 acquires an operation start time of a facility by referring to the facility use data of each of the extracted past data sets or referring to an instruction given from the user (step S1301). Similarly, the data division unit 45 acquires an operation end time of the facility by referring to the facility use data of each of the extracted past data sets or referring to the instruction given from the user (step S1302). Then, the data division unit 45 divides each past data set into three sections based on the operation start time and the operation end time of the facility (step S1303).

In addition, the derivation of a regression formula will be described in detail. FIG. 9 is a flowchart illustrating the demand prediction method according to Embodiment 2. In FIG. 9, the process of step S14 in FIG. 7 is illustrated in detail. First, the regression formula deriving unit 43 selects one of the divided sections (step S1401). Next, the regression formula deriving unit 43 derives a regression formula in the selected section (step S1402). The regression formula deriving unit 43 determines whether or not regression formulas are derived for all the divided sections (step S1403). When regression formulas are not derived for all the divided sections (No in step S1403), the regression formula deriving unit 43 repeats the process of step S1402 while selecting unselected sections until regression formulas are derived for all the divided sections.

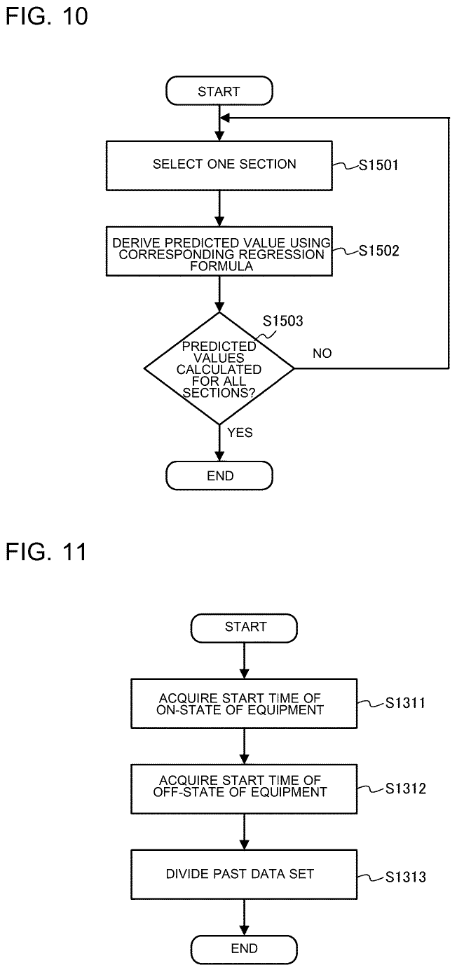

Furthermore, the calculation of a predicted value of data of a demand item will be described in detail. FIG. 10 is a flowchart illustrating the demand prediction method according to Embodiment 2. In FIG. 10, the process of step S15 in FIG. 7 is illustrated in detail. First, the predicted value calculation unit 44 select one of the divided sections (step S1501). Next, the predicted value calculation unit 44 calculates a predicted value of a demand item using the regression formula for the selected section (step S1502).

The predicted value calculation unit 44 determines whether or not predicted values of the demand item are calculated for all the divided sections (step S1503). When predicted values of the demand item are not calculated for all the divided sections (No in step S1503), the predicted value calculation unit 44 repeats the process of step S1502 while selecting unselected sections until predicted values of the demand item are calculated for all the divided sections.

As described above, according to Embodiment 2, the past data set is divided according to time zones and multiple kinds of regression formulas are constructed. Thus, the accuracy of the predicted value can be improved in consideration of a change tendency of a correlation between an explanatory variable and an objective variable, which varies from one time zone of the prediction target date and time to another. In particular, because a past data set is divided based on an operating status of the facility, the correlation between the explanatory variable and the objective variable can be improved, compared with the case where the past data set is divided simply for certain time zones.

It should be noted that, for example, in the case where the facility is not operated, the past data set is not divided. In this case, the regression formula deriving unit 43 and the predicted value calculation unit 44 derive a single regression formula for the entire past data sets to calculate a predicted value of the demand item, as described regarding Embodiment 1.

### Modification 1 of Embodiment 2

Modification 1 of Embodiment 2 is different from Embodiment 2 in the method for dividing the past data set. The data division unit 45 divides the past data set into a plurality of sections by referring to the operation state of equipment provided in the consumer, on the basis of the equipment operation data. The operation state indicates either an on-state indicating that the equipment is in operation or an off-state indicating that the equipment is in stopped state.

The data division unit 45 divides the past data set based on, for example, the start time of an on-state and the start time of an off-state in a target time of the past data set. Specifically, the data division unit 45 determines that the equipment is in the off-state in a time zone from start time of the target time of the past data set or the start time of the off-state to the start time of the on-state. Similarly, the data division unit 45 determines that the equipment is in the on-state in a time zone from the start time of the on-state to the start time of the off-state. Then, the past data set is divided into a plurality of sections based on whether the section corresponds to a time zone in which the equipment is determined to be in the on-state or a time zone in which the equipment is determined to be in the off-state. At this time, in the case where the duration of a time zone in which the equipment is in the off-state is less than a predetermined time, it is not necessary to determine the time zone as a time zone in which the equipment is in the off-state, at the time of dividing the past data set. The predetermine time is, for example, 60 minutes.

For example, in the case where the start time of a time zone in which the equipment is in the on-state is 7:00 and the start time of a time zone in which the equipment is in the off-state is 12:00, the data division unit 45 divides the past data set into three sections as follows: a time zone from 0:00 to 7:00 is determined as a time zone in which the equipment is in the off-state, a time period from 7:00 to 12:00 is determined as a time zone in which the equipment is in the on-state, and a time period from 12:00 to 23:59 is determined as a time period in which the equipment is in the off-state.

Furthermore, in the case where the target time of the past data set includes multiple time zones in each of which the equipment is in the off-state for a predetermined time or more, the data division unit 45 increases the number of partitions into which the past data set is to be divided, according to the number of time zones in each of which the equipment is in the off-state for the predetermined time or more. For example, in the case where the start time of a first time zone in which the equipment is in the on-state is 7:00, the start time of a first time zone in which the equipment is in the off-state is 12:00, the start time of a second time zone which the equipment is in the on-state is 13:00, and the start time of a second time zone in which the equipment is in the off-state is 17:00, the data division unit 45 divides the past data set into five sections as follows: a time zone from 0:00 to 7:00 is determined as a time zone in which the equipment is in the off-state, a time zone from 7:00 to 12:00 is determined as a time zone in which the equipment is in the on-state, a time zone from 12:00 to 13:00 is determined as a time zone in which the equipment is in the off-state, a time zone from 13:00 to 17:00 is determined as a time zone in which the equipment is in the on-state, and a time zone from 17:00 to 23:59 is determined as a time zoned in which the equipment is in the off-state.

The regression formula deriving unit 43 derives a regression formula for each of sections obtained by division by the data division unit 45. That is, a regression formula is derived based on data of sections in each of which where the equipment is in the on-state in all the extracted past data sets. Similarly, a regression formula is derived based on data of sections in each of which the equipment is in the off-state in all the extracted past data sets. It should be noted that different regression formulas may be derived for sections in each of which the equipment is in on-state and different regression formulas may be derived for sections in each of which the equipment is in the off-state. That is, different regressions formulas may be derived for sections in each of which the equipment is in on-state such that the regression formula derived for one section in which the equipment is in the on-state varies from the regression formula derived for another section in which the equipment is in the on-state; likewise, different regressions formulas may be derived for sections in each of which the equipment is in off-state such that the regression formula derived for one section in which the equipment is in the off-state varies from the regression formula derived for another section in which the equipment is in the off-state.

Furthermore, the division of the past data set will be described in detail. FIG. 11 is a flowchart illustrating a demand prediction method according to Modification 1 of Embodiment 2. In FIG. 11, the process of step S13 in FIG. 7 that is described above regarding Embodiment 2 is illustrated in detail. First, the data division unit 45 acquires the start time of an on-state by referring to the equipment operation data of each of the past data sets extracted by the degree-of-similarity determination unit 42 (step S1311). Next, the data division unit 45 acquires the start time of an off-state by referring to the equipment operation data of each of the past data sets extracted by the degree-of-similarity determination unit 42 (step S1312). Next, the data division unit 45 divides the past data set into a plurality of sections based on the acquired start times of the on-state and the off-state (step S1313) As described above, according to Modification 1 of Embodiment 2, the past data set is divided for time zones and multiple kinds of regression formula are constructed.

It is therefore possible to improve the accuracy of a predicted value in consideration of a change tendency of a correlation between an explanatory variable and an objective variable, which varies from one time zone of the prediction target date and time to another. In particular, because the past data set is divided based on an operation state of the equipment, the correlation between the explanatory variable and the objective variable can be improved, compared with the case where the past data set is divided simply for fixed time zones.

### Modification 2 of Embodiment 2

Modification 2 of Embodiment 2 is different from Embodiment 2 or Modification 1 of Embodiment 2 in the method for dividing the past data set. The data division unit 45 extracts time and the number X of sections in each of which a correlation coefficient between a demand item and a load item in each section is higher than or equal to a predetermined value, and divides the past data set into a plurality of sections based on the extracted number X of sections and time.

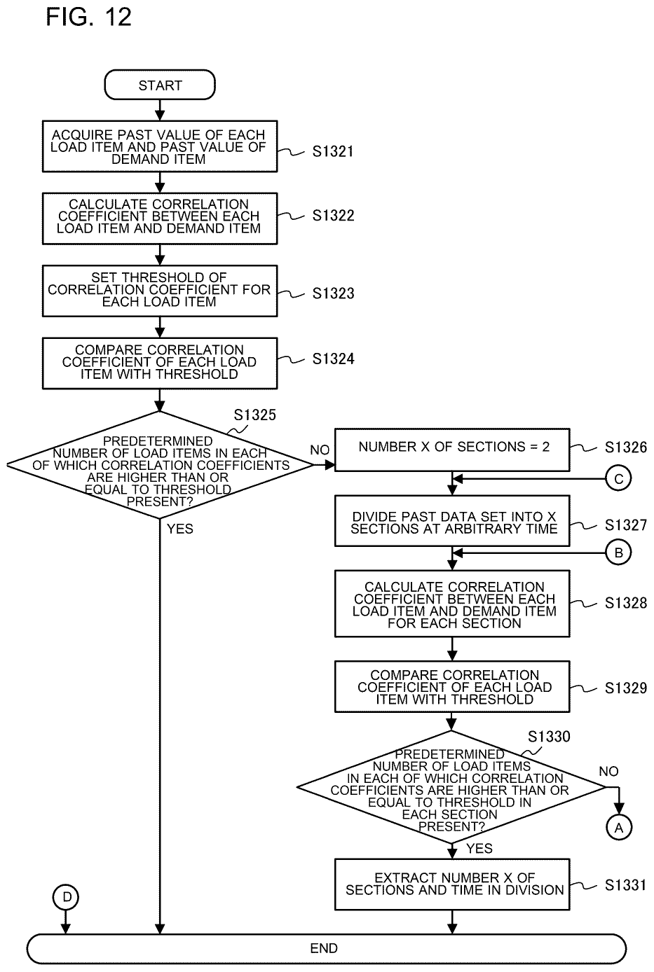

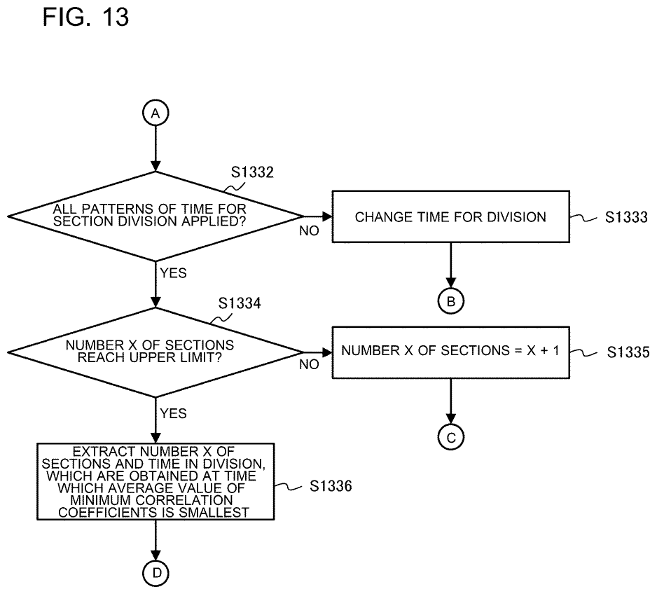

Furthermore, the division of the past data set will be described in detail. FIG. 12 is a flowchart indicating steps of a demand prediction method according to Modification 2 of Embodiment 2. FIG. 13 is a flowchart indicating other steps of the demand prediction method according to Modification 2 of Embodiment 2. FIGS. 11, 12 and 13 illustrate in detail the process of step S13 of FIG. 7 that is described regarding Embodiment 2. FIGS. 12 and 13 illustrate consecutive processes. First, the data division unit 45 acquires a past value of each load item and a past value of a demand item from all the past data sets extracted by the degree-of-similarity determination unit 42 (step S1321). Next, the data division unit 45 performs a multiple regression analysis on the acquired data items, and calculates a correlation coefficient between each load item and demand item for the entire extracted past data sets (step S1322). In this case, in the multiple regression analysis, a past value of each of load items selected by an inference unit 72 is determined as an explanatory variable and a past value of the demand item is determined as an objective variable.

Then, the data division unit 45 sets a threshold of a correlation coefficient for each load item (step S1323). This threshold is used in a subsequent processing, and refers to an arbitrary value input in advance by the user. The data division unit 45 compares the correlation coefficient of each load item with the threshold associated with the load item (step S1324), and determines whether or not the number of data items in each of which the correlation coefficient is higher than or equal to the threshold is larger than or equal to a predetermined number (step S1325). This predetermined number is an arbitrary number of items that is set in advance by the user. When the number of data items in each of which the correlation coefficient is higher than or equal to the threshold is larger than or equal to the predetermined number (Yes in step S1325), the processing is ended without dividing the past data set.

When the number of data items whose correlation coefficients are higher than or equal to the threshold is less than the predetermined number (No in step S1325), the data division unit 45 calculates a correlation coefficient between the load item and the demand item in each of cases, while changing the number X of sections and time at which the past data set is divided. Then, the data division unit 45 searches for a dividing pattern in which the correlation coefficient satisfies a predetermined condition. Then, the data division unit 45 extracts time and the number X of sections of the dividing pattern in which the correlation coefficient satisfies the predetermined condition. First, the data division unit 45 sets the number X of sections into which the past data set is divided to 2 (step S1326). Next, the data division unit 45 divides each of all the past data sets into X sections at common time (step S1327). For example, in the case where the number X of sections is two, the past data set of one day is divided into two sections. The minimum unit of time in division of the past data set is set in advance by the user. In addition, the time at which the past data set is divided may be selected in turn from the top of the past data set or may be selected at random. For example, in the case where the minimum unit in the division is 30 minutes and the past data set is divided into two sections from the top, the past data set is first divided into two sections, which are, for example, a time period from 0:00 to 0:29 and a time period from 0:30 to 23:59. Then, the data division unit 45 performs a multiple regression analysis on the data items acquired in step S1321 in each of divided sections, and calculates a correlation coefficient between each load item and demand item for the entire extracted past data sets (step S1328).

Then, the data division unit 45 compares the correlation coefficient of each load item with the threshold associated with the load item (step S1329), and determines whether or not the number of data items whose correlation coefficients are each higher than or equal to the threshold in each section is larger than or equal to a predetermined number (step S1330). This determination is the same as in the process of step S1325. When the number of data items whose correlation coefficients are each higher than or equal to the threshold in all the sections is larger than or equal to the predetermined (Yes in step S1330), the data division unit 45 extracts the number of sections obtained by the division in the process of step S1327 and the time selected in the division (step S1331), and ends the processing.

In the case where at least one section in which the number of data items whose correlation coefficients higher than or equal to the threshold is less than the predetermined number is present (No in step S1330), the data division unit 45 determines whether or not all the patterns of time at which the past data set is divided are applied (step S1332). It should be noted that in the case where, for example, the past data set is a past data set for 24 hours from 0:00 to 23:59, the minimum unit of the time in the division is 30 minutes, and the number X of sections is 2, times are 0:30, 1:00, . . . 23:00, and 23:30 that are patterns of time in the division, and the total number of the patterns of time is 47. In the case where not all the patterns of time in the division are applied (No in step S1332), the data division unit 45 changes the time at which the division is performed (step S1333), and re-executes the processes of steps S1328 to S1330. At this time, the time at which the division is performed may be selected in turn from the top of unselected times or may be selected at random.

When all the patterns of time in the division are applied (Yes in step S1332), the data division unit 45 determines whether or not the number X of sections reaches the upper limit of the number of times the division can be carried out (step S1334). It should be noted that in the case where, for example, the past data set covers 24 hours from 0:00 to 23:59 and the minimum unit of the time in the division is 30 minutes, the upper limit of the number X of sections is 48 sections in total, which correspond to a time period from 0:00 to 0:29, a time period from 0:30 to 0:59, . . . , a time period from 23:00 to 23:29, and a time period from 23:30 to 23:59. When the number X of the sections does not reach the upper limit of the number of times the division can be carried out (No in step S1334), the data division unit 45 increments the number X of the sections by 1 (step S1335) and re-executes the processes of steps S1327 to S1330.

When the number X of sections reaches the upper limit for the division (Yes in step S1334), the data division unit 45 extracts the number X of sections and the time selected in the division, which are obtained at the time when the average value of the minimum correlation coefficients of the sections is the minimum value, from among the results obtained through the previous processing (step S1336). The minimum correlation coefficient is the minimum value of correlation coefficients of each of load items in the sections that are calculated in step S1328. For example, it is assumed that the past data set is divided into a section a and a section 3; a data item A and a data item B are present as load items; in the section a, correlation coefficients of the data item A and the data item B are 0.45 and 0.55, respectively, and in the section B, correlation coefficients of the data item A and the data item B are 0.70 and 0.65, respectively. In this case, the minimum correlation coefficient in the section a is 0.45 for the data item A, and the minimum correlation coefficient in the section 3 is 0.65 for the data item B. Thus, the data division unit 45 extracts the number X of sections and the time in the division, which are obtained at the time when the average value of the correlation coefficient of 0.45 for the data item A and the correlation coefficient of 0.65 for the data item B is the minimum value.

As described above, according to Modification 2 of Embodiment 2, the past data set is divided for time zones and multiple kinds of regression formula are constructed. It is therefore possible to improve the accuracy of the predicted value in consideration of a change tendency of a correlation between an explanatory variable and an objective variable, which varies from one time zone of the prediction target date and time to another. In particular, because the past data set is divided such that a correlation coefficient between a demand item and a load item in each section reaches a predetermined value or higher, the correlation between the explanatory variable and the objective variable can be improved, compared with the case where the past data set is divided simply for fixed time zones.

### Embodiment 3

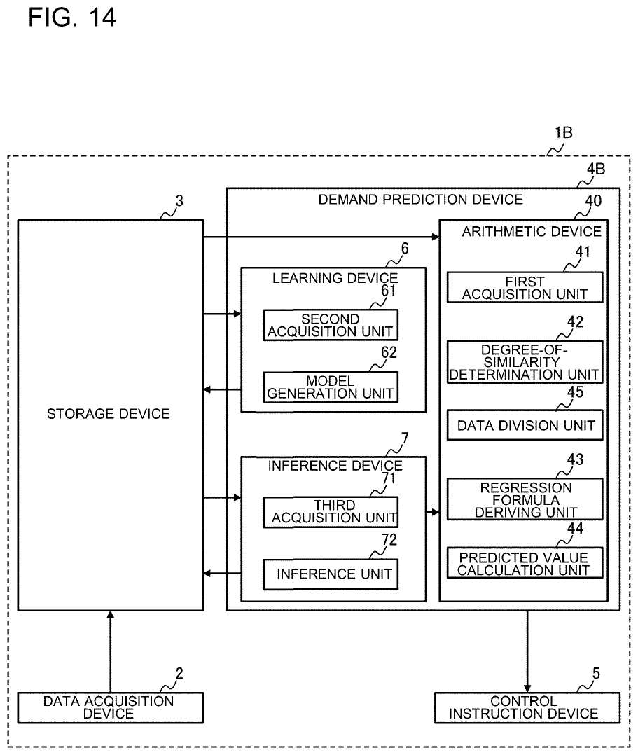

FIG. 14 is a schematic configuration diagram illustrating a demand prediction system 1B according to Embodiment 3. As illustrated in FIG. 14, a demand prediction device 4B of the demand prediction system 1B includes a learning device 6 and an inference device 7. In this regard, Embodiment 3 is different from that of Embodiment 2. In the processing by the learning device 6 and the inference device 7, artificial intelligence (Al) is used. Regarding Embodiment 3, components that are the same as or similar to those of Embodiment 2 will be denoted by the same reference signs and their descriptions will thus be omitted. The following description is made by referring mainly to the differences between Embodiments 2 and 3.

The demand prediction device 4B of the demand prediction system 1B includes an arithmetic device 40, the learning device 6, and the inference device 7. The arithmetic device 40 includes the first acquisition unit 41, the degree-of-similarity determination unit 42, the regression formula deriving unit 43, the predicted value calculation unit 44, and the data division unit 45 that are described above regarding Embodiment 3.

The learning device 6 is, for example, a computer, and includes a second acquisition unit 61 and a model production unit 62. Via a network, the second acquisition unit 61 acquires, as a learning data set, a past data set including a past value of a load item stored in the storage device 3 and a past value of a demand item associated with the load item. The model production unit 62 produces, by using the learning data set, a learned model for inferring the kind of a load item for use in determination of the degree of similarity determination from the load items included in a prediction data set. Specifically, the model production unit 62 produces a model by calculating a correlation coefficient between a demand item and each of load items included in the learning data set. The model production unit 62 stores the produced learned model in the storage device 3. In the case where the past value of the load item or demand item is not updated from the time when the model is produced previously, the generation of the model may be omitted.

The inference device 7 is, for example, a computer, and includes a third acquisition unit 71 and an inference unit 72. Via the network, the third acquisition unit 71 acquires a learned model and the kind of load item included in a prediction data set stored in the storage device 3. A load item included in a prediction data set is a candidate load item for use in determination of the degree of the similarity-of-similarity. The inference unit 72 selects a load item for use in determination of the degree of similarity, on the basis of the kind of a load item input from the third acquisition unit 71. Specifically, the inference unit 72 acquires kinds of a predetermined number of load items having high correlation coefficients with the demand item output from the learned model by inputting, to the learned model, the kinds of the load items input from the third acquisition unit 71. The number of load items to be output is set in advance by the user. The inference unit 72 transmits the kind of a load item for use in determination of the degree of similarity to the demand prediction device 4B.

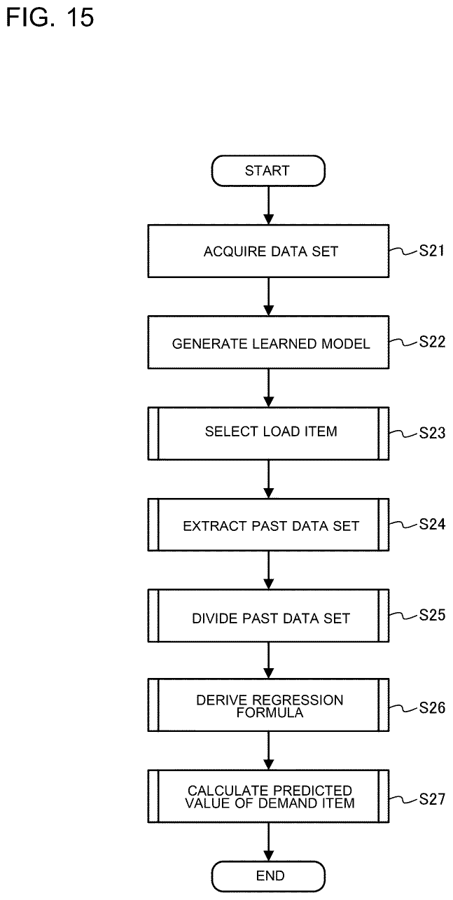

FIG. 15 is a flowchart illustrating a demand prediction method according to Embodiment 3. A schematic flow of processes that are executed to calculate an energy demand will be described with reference to FIG. 15. First, the first acquisition unit 41 acquires a predetermined amount of past data sets accumulated in the storage device 3 and a prediction data set of a prediction target date and time (step S21). Next, the learning device 6 produces a learned model for inferring a data item for use in determination of the degree of similarity from load items included in the prediction data set, by using the learning data set acquired by the second acquisition unit 61 of the learning device 6 (step S22). Then, the inference device 7 selects a load item for use in determination of the degree of similarity based on the learned model and the prediction data set acquired from the third acquisition unit 71 of the inference device 7 (step S23). In addition, the degree-of-similarity determination unit 42 determines the overall degree of similarity of the past data set based on the selected load item, and based on this degree of similarity, extracts a past data set having a high degree of similarity to the prediction target date and time (step S24). Furthermore, the data division unit 45 divides the extracted past data set into a plurality of sections (step S25). Next, the regression formula deriving unit 43 derives a regression formula for calculation of a predicted value of a demand item for each of sections of the extracted past data set (step S26). Then, the predicted value calculation unit 44 calculates a predicted value of the demand item from a predicted value of a load item of the prediction target date and time based on the regression formula derived by the regression formula deriving unit 43 (step S27).

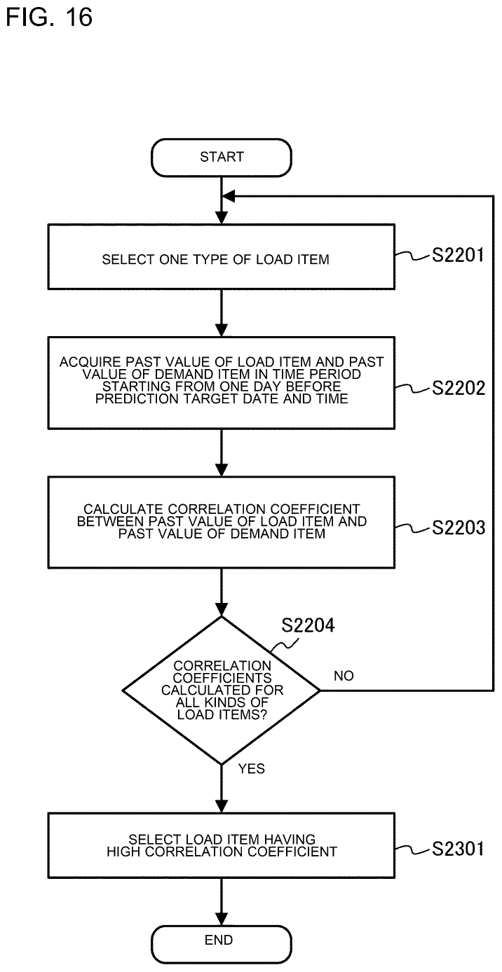

Furthermore, the generation of a learned model and the selection of a load item will be described in detail. FIG. 16 is a flowchart illustrating the demand prediction method according to Embodiment 3. In FIG. 16, the processes of steps S22 and S23 in FIG. 15 are illustrated in detail. First, the model production unit 62 of the learning device 6 selects a single kind of a load item from the load items included in the learning data set acquired by the second acquisition unit 61 (step S2201). Next, the model production unit 62 acquires a past value of the selected load item and a past value of a demand item by using, as a learning data set, a past data set of a period including one or more days before the prediction target date and time (step S2202). Then, the model production unit 62 calculates a correlation coefficient between the past value of the selected load item and the past value of the demand item for the entire leaning data set (step S2203). The model production unit 62 determines whether or not correlation coefficients are calculated for all kinds of load items included in the learning data set (step S2204). When correlation coefficients are not calculated for the all kinds of load items of all kinds included in the learning data set (No in step S2204), the processes of steps S2201 to S2203 are repeated while selecting unselected load items until the correlation coefficients are calculated for the all kinds of load items included in the learning data set. When correlation coefficients are calculated for the all kinds of load items included in the learning data set (Yes in S2204), the generation of a learned model is completed. Then, by inputting kinds of load items included in the prediction data set acquired by the third acquisition unit 71 into the learned model, the inference unit 72 of the inference device 7 selects a predetermined number of load items having high correlation coefficients to the demand item (step S2301).

According to Embodiment 3, the kind of a load item for use in determination of the degree of similarity is selected based on correlation coefficient between load items and demand items. Thus, the determination of the degree of similarity and the accuracy of prediction of an energy demand can be further improved.

It should be noted that although it is described above that the learning device 6 produces a model for a load item included in a learning data set, that is a past data set, a model may be produced for a load item included in a prediction data set.

### Modification 1 Of Embodiment 3

Modification 1 of Embodiment 3 is different from Embodiment 3 in that the method for producing a learned model and the method for selecting a load item. The model production unit 62 of the learning device 6 calculates, for each load item, an error between a predicted value of a demand item calculated from a single regression formula between the load item and a demand item and a past value of the demand item, and produces a model. The inference unit 72 of the inference device 7 acquires a predetermined number of load items having a small error between a predicted value and a past value of a demand item output from a learned model by inputting, into the learned model, the kind of a candidate load item included in a prediction data set. The number of load items to be output is set in advance by the user.

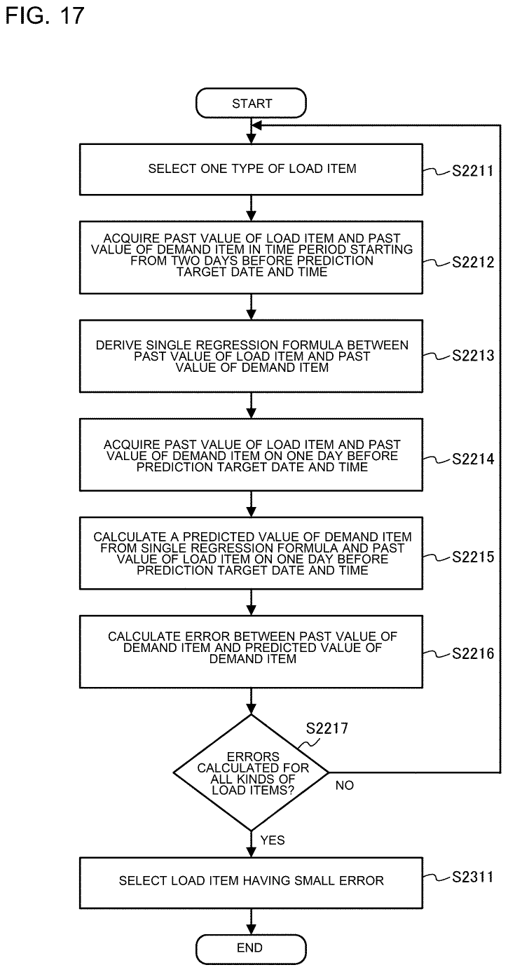

Furthermore, the generation of a learned model and the selection of a load item will be described in detail. FIG. 17 is a flowchart illustrating a demand prediction method according to Modification 1 of Embodiment 3. In FIG. 17, the processes of steps S22 and S23 of FIG. 15 are illustrated in detail. First, the model production unit 62 of the learning device 6 selects one kind of load item from the load items included in the learning data set acquired by the second acquisition unit 61 (step S2211). Next, the model production unit 62 acquires a past value of the selected load item and a past value of a demand item by using, as a learning data set, a past data set of a period two or more days before the prediction target date and time (step S2212). Then, the model production unit 62 derives, for the entire learning data set, a single regression formula using a past value of the acquired load item as an explanatory variable and the past value of the demand item as an objective variable (step S2213).

In addition, the model production unit 62 acquires a past value of the load item selected in step S2211 and a past value of the demand item of one day before the prediction target date and time (step S2214). Next, the model production unit 62 calculate a predicted value of the demand item by using the single regression formula derived in step S2213 and the past value of the load item acquired in step S2214 (step S2215). Then, the model production unit 62 compares the past value of the demand item acquired in step S2214 with the predicted value of the demand item calculated in step S2215 and calculates an error between them (step S2216). The error is, for example, an RMSE.

The model production unit 62 determines whether or not errors are calculated for all kinds of load items included in the learning data set (step S2217). In the case where errors are not calculated for all kinds of load items included in the learning data set (No in step S2217), unselected load items are selected and the processes of steps S2211 to S2216 are repeated, errors are calculated for all kinds of load items included in the learning data set. In the case where errors are calculated for all kinds of load items included in the learning data set (Yes in step S2217), the generation of a learned model is completed. Then, by inputting the kind of a load item included in the prediction data set acquired by the third acquisition unit 71 into the learned model, the inference unit 72 of the inference device 7 selects a predetermined number of load items each having a small error between the predicted value and the past value of the demand item (step S2311).

In Modification 1 of Embodiment 3, the kind of a load item for use in determination of the degree of similarity is selected by calculating, for each load item, an error between a past value of the demand item and a predicted value of the demand item calculated by a single regression formula of the load item and the demand item.

Thus, the determination of the degree of similarity can be further improved and in addition, the accuracy of prediction of an energy demand can also be further improved.

### Embodiment 4

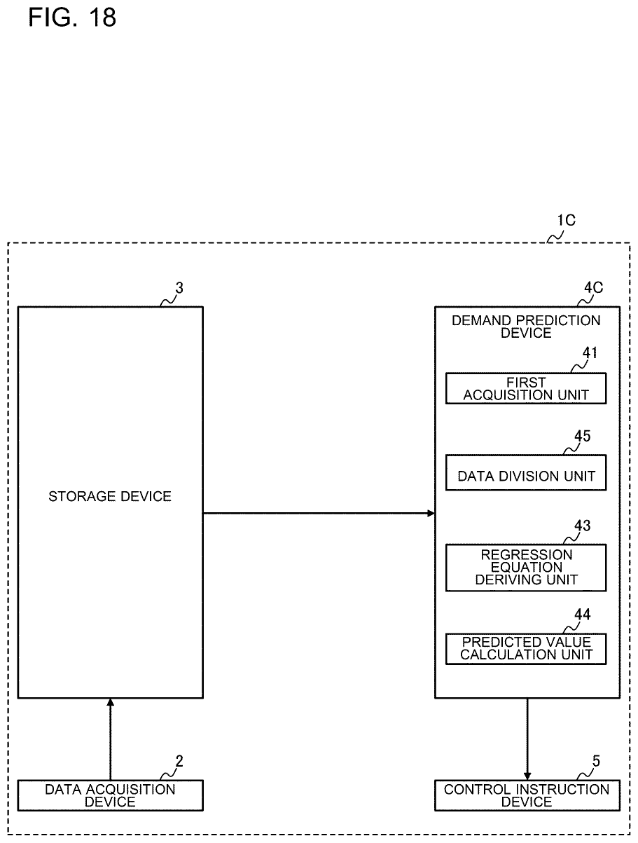

FIG. 18 is a schematic configuration diagram illustrating a demand prediction system 1C according to Embodiment 4. As illustrated in FIG. 18, a demand prediction device 4C according to Embodiment 4 does not include a degree-of-similarity determination unit 42. In this regard, Embodiment 4 is different from Embodiment 2. In Embodiment 4, components that are the same as Embodiment 2 will be denoted by the same reference signs and their descriptions will thus be omitted. The following description is made by referring mainly to the differences between Embodiments 2 and 4.

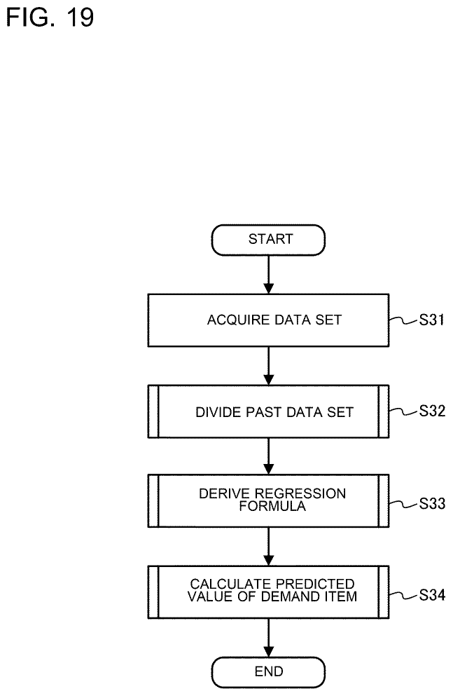

FIG. 19 is a flowchart illustrating a demand prediction method according to Embodiment 4. A schematic flow of processes that are executed until an energy demand is calculated will be described with reference to FIG. 19. First, the first acquisition unit 41 of the demand prediction device 4C acquires a predetermined amount of past data sets accumulated in the storage device 3 and a prediction data set of a prediction target date and time (step S31). Then, the data division unit 45 divides a past data set into a plurality of sections (step S32). Then, the regression formula deriving unit 43 derives, for each of the sections of the past data set, a regression formula for calculating a predicted value of a demand item (step S33). Then, the predicted value calculation unit 44 calculates a predicted value of the demand item from a predicted value of a load item of the prediction target date and time based on the regression formula derived by the regression formula deriving unit 43 (step S34).

As described above, in the demand prediction device 4C and the demand prediction method of Embodiment 4, an energy demand is predicted based on a past data set having a high degree of similarity to the prediction target date and time. Thus, the accuracy of prediction of the energy demand is improved.

Although the embodiments of the present disclosure are described above, the present disclosure is not limited to the configurations of the above embodiments, and various modifications or combinations of the configurations can be made within the scope of the technical concept. For example, regarding the embodiments, it is described above that the data acquisition device 2 and the storage device 3 communicate with each other via the network, such as the Internet; the storage device 3 and the demand prediction device 4 communicate with each other via the network, such as the Internet; and the demand prediction device 4 and the control instruction device 5 communicate with each other via the network, such as the Internet. However, some of the data acquisition device 2, the storage device 3, the demand prediction device 4, and the control instruction device 5 may be integrated and provided as an information procession device, such as a server.

Furthermore, the learning device 6 or the inference device 7 may be provided outside the demand prediction device 4 and may be configured to communicate with the demand prediction device 4 via the network, such as the Internet.

Moreover, the data division unit 45 described regarding Embodiment 2 may be omitted from the demand prediction system 1B described regarding Embodiment 3.

### REFERENCE SIGNS LIST

1, 1A, 1B, 1C: demand prediction system, 2: data acquisition device, 3: storage device, 4, 4A, 4B, 4C: demand prediction device, 5: control instruction device, 6: learning device, 7: inference device, 40: arithmetic device, 41: first acquisition unit, 42: degree-of-similarity determination unit, 43: regression formula deriving unit, 44: predicted value calculation unit, 45: data division unit, 61: second acquisition unit, 62: model production unit, 71: third acquisition unit, 72: inference unit, 101: processor, 102: memory, 103: bus

1. A demand prediction device that predicts an energy demand of a consumer at a prediction target date and time, the demand prediction device comprising:
a memory; and
a processor,
wherein the processor is configured to:
acquire a past data set and a predicted value of a load item that affects the energy demand, the past data set including a past value of the load item and a past value of a demand item indicating the energy demand;
a determine a degree of similarity between the predicted value of the load item and the past value of the load item, and extract the past data set based on the degree of similarity;
divide the past data set into a plurality of sections with reference to time based on an operating status of the consumer;
derive a regression formula for prediction of the energy demand that is made based on the extracted past data set, for each of the plurality of sections; and
calculate a predicted value of the demand item by applying the predicted value of the load item to the regression formula.

2-3. (canceled)

4. The demand prediction device of claim 1, wherein the processor is configured to divide the past data set into the plurality of sections based on an operation state of equipment provided in the consumer.

5. The demand prediction device of claim 1, wherein the processor is configured to divide the past data set into the plurality of sections such that a correlation coefficient between the demand item and the load item in each of the plurality of sections is higher than or equal to a predetermined value.

6. The demand prediction device of claim 1, wherein the processor is configured to
acquire a learning data set including the load item and the demand item, and
produce, using the learning data set, a learned model for inference of the load item for use in the determination of the degree of similarity from the load items that are applied as candidate load items.

7. The demand prediction device of claim 1, wherein the processor is configured to
acquire a kind of the load item that is applied as a candidate load item for use in the determination of the degree of similarity to the demand item, and
select the load item for use in the determination of the degree of similarity from the load items that are applied as candidate load items, based on the kind of the load item by using the learned model for inference of the load item for use in the determination of the degree of similarity.

8. A demand prediction system comprising:
the demand prediction device of claim 1; a storage device configured to store the past data set and a predicted value of the load item; and
a data acquisition device configured to acquire the past data set and the predicted value of the load item, and store the past data set and the predicted value of the load item in the storage device.

9. A demand prediction method of predicting an energy demand of a consumer at a prediction target date and time, the demand prediction method comprising:
acquiring a past data set and a predicted value of a load item that affects the energy demand, the past data set including a past value of the load item and a past value of a demand item indicating the energy demand;
determining a degree of similarity between the predicted value of the load item and the past value of the load item and extracting the past data set based on the degree of similarity;
dividing the past data set into a plurality of sections with reference to time based on an operating status of the consumer;
deriving a regression formula for prediction of the energy demand that is made based on the extracted past data set, for each of the plurality of sections; and
calculating a predicted value of the demand item by applying the predicted value of the load item to the regression formula.
